(19) United States
(12) Patent Application Publication
(10) Pub. No.: US 2026/0088276 A1
(43) Pub. Date: Mar. 26, 2026

(54) ELECTRODE PLATE DRYING APPARATUS

(71) Applicant: SAMSUNG SDI CO., LTD., Yongin-si (KR)

(72) Inventors: Youngwoong KWON, Yongin-si (KR); Gi Jong MOON, Yongin-si (KR)

(21) Appl. No.: 19/270,172

(22) Filed: Jul. 15, 2025

(30) Foreign Application Priority Data
Sep. 25, 2024 (KR) 10-2024-0130154

(51) Int. Cl. H01M 4/04; F26B 3/30; F26B 21/02

(52) U.S. Cl. CPC H01M 4/0471; F26B 3/30; F26B 21/20

(57) ABSTRACT

An electrode plate drying apparatus includes a drying chamber accommodating an electrode plate; a support member supporting the electrode plate inside the drying chamber; a lamp portion within the drying chamber and configured to emit drying heat in a direction of the electrode plate; and a reflective portion on a ceiling of the drying chamber and having a portion of a curved shape to reflect the drying heat in the direction of the electrode plate.

### CROSS-REFERENCE TO RELATED APPLICATION

The present application claims priority to and the benefit of Korean Patent Application No. 10-2024-0130154, filed on Sep. 25, 2024, in the Korean Intellectual Property Office, the entire disclosure of which is incorporated herein by reference.

### BACKGROUND

### 1. Field

Aspects of the present disclosure relate to an electrode plate drying apparatus.

### 2. Description of the Related Art

Generally, a wet coating method is used in the manufacturing process of an electrode plate of a lithium ion battery.

This wet coating method mixes positive and negative active materials with a binder in the form of a slurry, coats it on a thin metal foil, and removes the solvent contained in the slurry by evaporation during a subsequent drying process.

Non-uniform drying during the manufacturing process of the electrode plate may affect the mechanical properties of the electrode plate, potentially leading to performance degradation or a shortened lifespan of the battery.

Therefore, in the drying process of the electrode plate, the drying temperature, time, drying method, uniform temperature distribution, and proper ventilation are important.

In this way, optimization of the drying process of the electrode plate not only improves the efficiency of the lithium ion battery manufacturing process, but also plays an important role in maximizing the performance and stability of the battery.

One among various drying methods is infrared drying, which uses infrared rays to directly transfer heat to the electrode plate. Infrared drying is frequently used because it has the advantage of being able to transfer heat directly to the inside of the electrode plate.

However, the above-described conventional method of drying the electrode plate has a problem in that drying efficiency is reduced because infrared rays for drying are frequently not effectively transmitted to the electrode plate.

### SUMMARY

Aspects of some embodiments of the present disclosure are directed to an electrode plate drying apparatus that improves an electrode plate drying effect by installing a reflective portion that reflects drying heat emitted from a lamp portion toward an electrode plate in a curved state such that the drying heat is stably irradiated toward the electrode plate.

According to some embodiments of the present disclosure, there is provided an electrode plate drying apparatus including: a drying chamber accommodating an electrode plate; a support member supporting the electrode plate inside the drying chamber; a lamp portion within the drying chamber and configured to emit drying heat in a direction of the electrode plate; and a reflective portion on a ceiling of the drying chamber and having a portion of a curved shape to reflect the drying heat in the direction of the electrode plate.

In some embodiments, the reflective portion includes: a first reflective portion configured to reflect the drying heat in a first direction; and a second reflective portion obliquely connected to a side surface of the first reflective portion and configured to reflect the drying heat in a second direction different from the first direction.

In some embodiments, the first reflective portion is obliquely connected to a side surface of the second reflective portion at a first angle.

In some embodiments, a plurality of first perforated holes are formed on a surface of the first reflective portion.

In some embodiments, a plurality of the second reflective portions are obliquely connected to the side surface of the first reflective portion at a second angle.

In some embodiments, a plurality of second perforated holes are formed on a surface of the second reflective portion.

In some embodiments, the first reflective portion and the second reflective portion are connected to each other at an acute angle range.

In some embodiments, a plurality of reflective portions are installed on the ceiling of the drying chamber.

In some embodiments, a hot air supply portion supplying hot air in the direction of the electrode plate is installed on an upper portion of the drying chamber.

In some embodiments, the hot air supply portion includes: an air supply portion on the upper portion of the drying chamber, and configured to receive hot air and to supply it to an inside of the drying chamber; and a guide portion configured to guide the hot air supplied through the air supply portion to be supplied to the inside of the drying chamber.

In some embodiments, a plurality of air supply portions are installed on the upper portion of the drying chamber.

In some embodiments, the guide portion has one side on which the an air supply portion of the plurality of air supply portions is installed and protrudes from an upper side of the drying chamber toward the inside of the drying chamber to guide the supply of hot air.

In some embodiments, the second reflective portion is rotatably connected to a side surface of the first reflective portion.

In some embodiments, a driving portion is on a side surface of the second reflective portion in the drying chamber and is configured to provide a rotational driving force to the second reflective portion.

In some embodiments, the driving portion is a cylinder member in which a rod portion is connected to a side surface of the second reflective portion.

According to some embodiments of the present disclosure, a curved reflective portion is installed on an upper portion of a lamp portion, so that heat generated from the lamp portion is stably reflected toward an electrode plate by the reflective portion, thereby effectively drying the electrode plate.

### BRIEF DESCRIPTION OF THE DRAWINGS

FIG. 1 illustrates a schematic perspective view of an electrode plate drying apparatus according to some embodiments of the present disclosure.

FIG. 2 illustrates a schematic cross-sectional view taken along the line II-II of the electrode plate drying apparatus of FIG. 1, according to some embodiments of the present disclosure.

FIG. 3 schematically illustrates a partial side cross-sectional view of a state in which a reflective portion is installed according to some embodiments of the present disclosure.

FIG. 4 schematically illustrates a partial side cross-sectional view of a state in which a reflective portion is installed according to some other embodiments of the present disclosure.

FIG. 5 schematically illustrates a partial side cross-sectional view of a state in which an angle of the reflective portion of FIG. 4 is changed, according to some embodiments of the present disclosure.

### DETAILED DESCRIPTION

The present disclosure will be described more fully hereinafter with reference to the accompanying drawings, in which embodiments of the invention are shown. As those skilled in the art would realize, the described embodiments may be modified in various different ways, all without departing from the spirit or scope of the present disclosure. The drawings and description are to be regarded as illustrative in nature and not restrictive. Like reference numerals designate like elements throughout the specification.

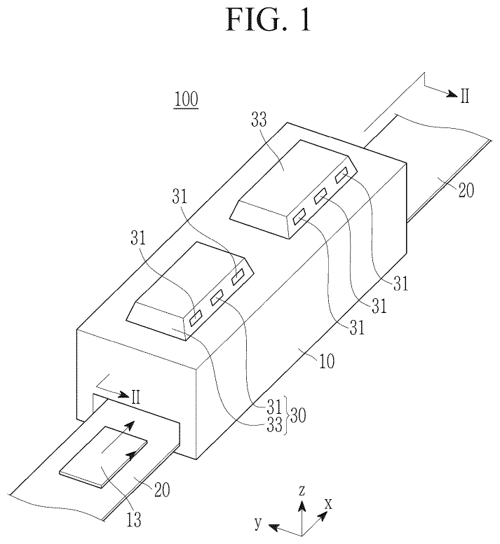

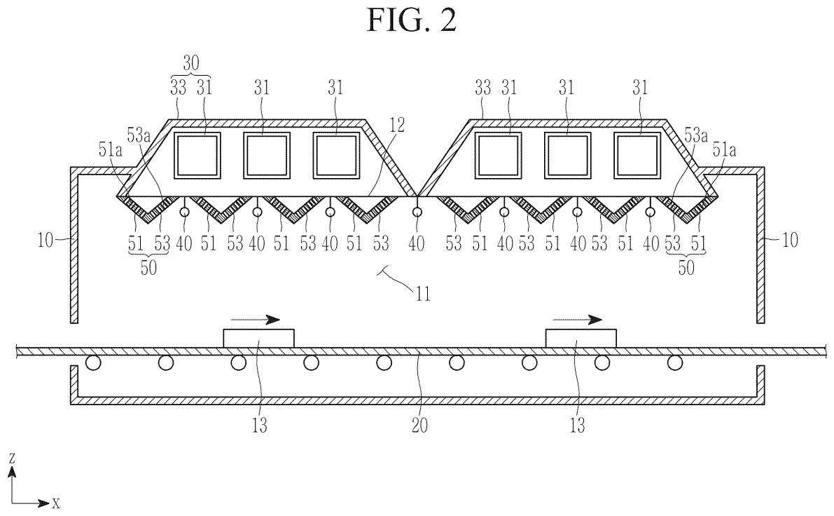

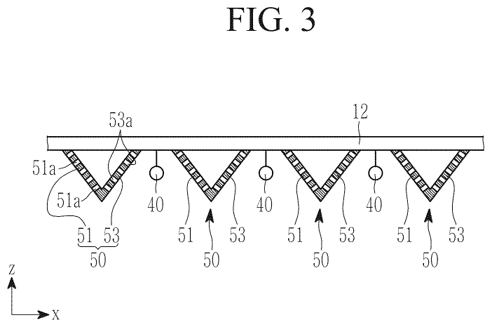

FIG. 1 illustrates a schematic perspective view of an electrode plate drying apparatus according to some embodiments of the present disclosure; FIG. 2 illustrates a schematic cross-sectional view taken along the line II-II of the electrode plate drying apparatus of FIG. 1, according to some embodiments of the present disclosure; and FIG. 3 schematically illustrates a partial side cross-sectional view of a state in which a reflective portion is installed according to some embodiments of the present disclosure.

As shown in FIG. 1 to FIG. 3, an electrode plate drying apparatus 100 according to some embodiments of the present disclosure includes a drying chamber 10 in which an electrode plate 13 is accommodated, a support portion 20 supporting the electrode plate inside the drying chamber 10, a lamp portion 40 installed inside the drying chamber 10 to radiate dry heat toward the electrode plate, and a reflective portion 50 installed on the ceiling of the drying chamber 10 and partially curved to reflect dry heat toward the electrode plate 13.

The reflective portion 50 installed on the ceiling 12 of the drying chamber 10 reflects the drying heat toward the electrode plate 13.

The drying chamber 10 is installed so that the electrode plate 13 may be accommodated therein, and an accommodation space for accommodating the electrode plate 13 may be formed therein.

The drying chamber 10 may be installed on the floor of the work space in a substantially hexahedral shape. However the drying chamber 10 is not necessarily limited to a hexahedral shape, and a portion of the outer surface thereof may be changed to any suitable shape, such as a round shape.

The support portion 20 supporting the electrode plate may be installed in the drying chamber 10.

The support member 20 may be installed so that the electrode plate 13 may be positioned in the correct position inside the drying chamber 10 or the electrode plate 13 may be conveyed to the outside of the drying chamber 10 in a dried state.

In some examples, the support portion 20 may be installed as a conveying conveyor to convey the electrode plate 13 to the inside of the drying chamber 10 and to convey the dried electrode plate 13 to the outside of the drying chamber 10.

Hereinafter, the same reference number is used for both the support portion and the conveying conveyor.

The conveying conveyor 20 is installed so that it may pass through the drying chamber 10, and it may be installed so that the electrode plate 13 to be dried is introduced to one side of the drying chamber 10 and the dried electrode plate 13 may be discharged to the other side of the drying chamber 10 depending on the operation.

A hot air supply portion 30 for supplying hot air for drying may be installed on the upper side of the drying chamber 10.

A plurality of hot air supply portions 30 may be installed on the upper portion of the drying chamber 10 to supply hot air for drying to the electrode plate 13 positioned inside the drying chamber 10.

The hot air supply portion 30 may be installed to receive hot air from a predetermined hot air supply source and uniformly supply the hot air to the drying space 11 inside the drying chamber 10.

For example, the hot air supply portion 30 may include an air supply portion 31 that is installed at the upper portion of the drying chamber 10 and connected to a hot air supply source to receive hot air and supply it to the inside of the drying chamber 10, and a guide portion 33 that guides hot air to be supplied to the inside of the drying chamber 10 through the air supply portion 31.

The air supply portion 31 may be installed in an open state inside the drying chamber 10 to supply hot air to the inside of the drying chamber 10 from the upper side of the drying chamber 10.

The air supply portion 31 is installed to be connected to a predetermined hot air supply source through a duct or the like to receive hot air, and may be a connector open to the inside of the drying chamber 10.

At least three or more air supply portions 31 are installed on the upper side of the drying chamber 10 at positions spaced apart from each other, so that they may stably and uniformly supply hot air to the inside of the drying chamber 10.

The hot air supplied through the air supply portion 31 may be supplied into the drying chamber 10 by the guide portion 33.

The upper portion of the guide portion 33 is installed at the upper portion of the drying chamber 10, and the lower portion thereof may protrude in a gradually extended state in the downward direction of the drying chamber 10.

Accordingly, the guide portion 33 may guide hot air for drying to be appropriately supplied from the upper side of the drying chamber 10 toward the inside of the drying chamber 10.

On the other hand, a lamp portion 40 for emitting drying heat for drying the electrode plate 13 may be installed on the ceiling 12 of the drying chamber 10.

The lamp portion 40 may be installed on the ceiling 12 inside the drying chamber 10 and may be installed to emit heat for drying the electrode plate 13.

A plurality of lamp portions 40 may be installed on the inner ceiling 12 of the drying chamber 10 at equal intervals from each other.

The lamp portion 40 may be an IR lamp according to some embodiments. In other words, the lamp portion 40 is a lamp that emits infrared rays (IR), and may be installed to properly dry the electrode plate 13 by transmitting heat to the electrode plate 13.

On the other hand, between the lamp portion 40 and the ceiling 12 of the drying chamber 10, the reflective portion 50 may be installed to reflect the heat emitted from the lamp portion 40 in the direction of the electrode plate 13.

The reflective portion 50 is installed on the ceiling 12 of the drying chamber 10 between the plurality of lamp portions 40, so that the heat emitted from the lamp portion 40 may be reflected in the direction of the electrode plate 13 to facilitate the drying operation of the electrode plate 13.

The reflective portion 50 may be installed in a state in which a portion in the longitudinal direction is curved.

For example, the reflective portion 50 may include a first reflective portion 51 that reflects the drying heat in a first direction and a second reflective portion 53 that is obliquely connected to the side surface of the first reflective portion 51 and reflects the drying heat in a second direction different from the first direction. For example, the first and second reflective portions 51 and 53 of the reflective portion 50 may be connected to each other in an inclined state and installed in a curved state.

A plurality of first reflective portions 51 may be installed on the upper side of the drying chamber 10, and may be installed at a first angle with respect to the surface of the ceiling 12 at the upper portion of the drying chamber 10.

A first perforated hole 51a may be formed in the first reflective portion 51 so that the hot air supplied from the upper side of the drying chamber 10 is stably introduced toward the electrode plate 13.

A plurality of first perforated holes 51a are formed in the first reflective portion 51, and may be formed at equal intervals with respect to the entire area of the first reflective portion 51. The first perforated hole 51a may be formed to form a plurality of rows and columns on the surface of the first reflective portion 51. However, the number and size of the first perforated holes 51a are not particularly limited, but may be appropriately changed according to the size of the reflective portion.

The first perforated hole 51a may be formed in a circular shape through the first reflective portion 51, but is not particularly limited thereto, and may be formed in an elliptical shape or a polygonal shape.

The second reflective portion 53 may be installed on the side surface of the first reflective portion 51 in a state inclined at a second angle with respect to the surface of the ceiling 12 of the drying chamber 10. That is, the second reflective portion 53 is connected to the side surface of the first reflective portion 51, and may be installed at a second angle different from the first angle at which the first reflective portion 51 is installed.

A second perforated hole 53a may be formed in the second reflective portion 53 so that the hot air supplied from the upper side of the drying chamber 10 is stably introduced toward the electrode plate 13.

The second perforated hole 53a may be formed in a circular shape through the second reflective portion 53, but is not limited thereto, and may be formed in an elliptical shape or a polygonal shape.

A plurality of second perforated holes 53a are formed in the first reflective portion 51, and may be formed at equal intervals with respect to the entire area of the first reflective portion 51. The first perforated hole 51a may be formed to create a plurality of rows and columns on the surface of the first reflective portion 51. However, the number and size of the first perforated holes 51a are not particularly limited, but may be appropriately changed according to the size of the reflective portion.

The first reflective portion 51 and the second reflective portion 53 may be connected to each other at an angle of 90 degrees. However, the first reflective portion 51 and the second reflective portion 53 are not necessarily limited to being connected to each other at an angle of 90 degrees, and may be connected at a set or predetermined angle in the range of an obtuse angle or an acute angle.

As described above, in the electrode plate drying apparatus 100 of the present embodiment, the first reflective portion 51 and the second reflective portion 53 are obliquely connected to each other with the lamp portion 40 interposed therebetween, so that the heat generated from the lamp portion 40 may be reflected toward the electrode plate 13 by the first and second reflective portions 51 and 53.

Accordingly, the electrode plate 13 disposed inside the drying chamber 10 is smoothly supplied with hot air by the hot air supply portion 30 and irradiated with dry heat by the lamp portion 40, so that the electrode plate 13 may be effectively dried.

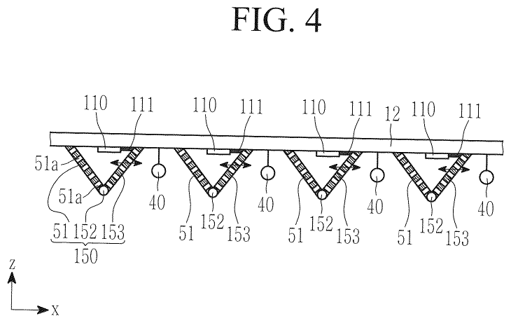

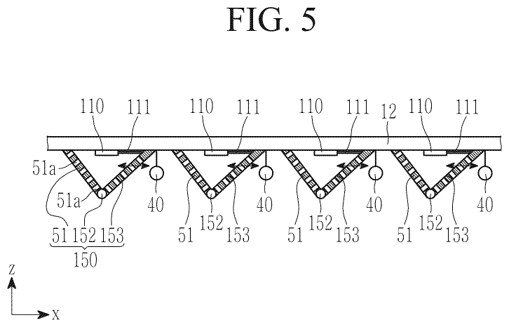

FIG. 4 schematically illustrates a partial side cross-sectional view of a state in which a reflective portion is installed according to some other embodiments of the present disclosure; and FIG. 5 schematically illustrates a partial side cross-sectional view of a state in which an angle of the reflective portion of FIG. 4 is changed, according to some embodiments of the present disclosure.

The same reference numerals as those in FIG. 1 to FIG. 3 refer to the same or similar members having the same or similar functions.

As illustrated in FIG. 4 and FIG. 5, the second reflective portion 53 of the electrode plate drying apparatus according to some other embodiments of the present disclosure may be rotatably connected to the side surface of the first reflective portion 51.

For example, the second reflective portion 53 may be rotatably connected to the side surface of the first reflective portion 51 by a link 152.

The second reflective portion 53 may be installed in a state where it is rotated at a predetermined angle with respect to the first reflective portion 51 by the driving force of a driving portion 110.

The driving portion 110 may be a cylinder member in which an end portion of a rod 111 is rotatably installed on the edge of the second reflective portion 53.

Hereinafter, the driving portion and the cylinder member use the same reference number.

The cylinder member 110 may be operated under the control of the operator to transmit a pressing force for rotation to the second reflective portion 53 according to the forward and backward movement of the rod 111.

Therefore, the second reflective portion 53 may be appropriately rotated at a set or predetermined angle with respect to the first reflective portion 51.

In this way, the second reflective portion 53 is rotated at a set or predetermined angle to adjust the angle at which the heat emitted from the lamp portion 40 is reflected.

To this end, first, a temperature sensor 60 is used to check the portion inside the drying chamber 10 where a relatively low temperature occurs.

Thereafter, the operator may check the position where a relatively low temperature portion inside the drying chamber 10 occurs, and control the driving portion 110 to adjust the angle of the second reflective portion 53, so that heat may be supplied to the relatively low temperature portion in the drying chamber 10.

That is, the portion where the electrode plate 13 is introduced and the portion where it is discharged in the drying chamber 10 are exposed to the outside air and have a relatively low temperature, so that by adjusting the angle of some of the plurality of second reflective portions 53 so that heat is irradiated, an appropriate temperature may be maintained, thereby improving the drying effect of the electrode plate 13.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section.

Thus, a first element, component, region, layer or section discussed below could be termed a second element, component, region, layer or section, without departing from the spirit and scope of the inventive concept.

In addition, it will also be understood that when a layer is referred to as being “between” two layers, it can be the only layer between the two layers, or one or more intervening layers may also be present.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” “comprising,” “has,” “have,” and “having,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. For example, the expression “A and/or B” denotes A, B, or A and B. Expressions such as “one or more of” and “at least one of,” when preceding a list of elements, modify the entire list of elements and do not modify the individual elements of the list. For example, the expression “one or more of A, B, and C,” “at least one of A, B, or C,” “at least one of A, B, and C,” and “at least one selected from the group consisting of A, B, and C” indicates only A, only B, only C, both A and B, both A and C, both B and C, or all of A, B, and C.

Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, “in contact with”, “in direct contact with”, or “immediately adjacent” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art. Further, if the term “substantially” is used in combination with a feature that could be expressed using a numeric value, the term “substantially” denotes a range of +/−5% of the value centered on the value.

Furthermore, a specific quantity or range recited in this written description or the claims may also encompass the inherent variations in measured or calculated values that would be recognized by those of ordinary skill in the art.

As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

While this disclosure has been described in connection with what is presently considered to be practical embodiments, it is to be understood that the disclosure is not limited to the disclosed embodiments, but, on the contrary, is intended to cover various suitable modifications and equivalent arrangements included within the spirit and scope of present disclosure as defined by the appended claims and their equivalents.

### DESCRIPTION OF SOME OF THE SYMBOLS

10: drying chamber
11: accommodation space
20: support portion, conveying conveyor
30: hot air supply portion
31: air supply portion
33: guide portion
40: lamp portion
50, 150: reflective portion
51: first reflective portion
51a: first perforated hole
53, 153: second reflective portion
53a: second perforated hole
60: temperature sensor
152: link

What is claimed is:

1. An electrode plate drying apparatus comprising:
a drying chamber accommodating an electrode plate;
a support member supporting the electrode plate inside the drying chamber;
a lamp portion within the drying chamber and configured to emit drying heat in a direction of the electrode plate; and
a reflective portion on a ceiling of the drying chamber and having a portion of a curved shape to reflect the drying heat in the direction of the electrode plate.

2. The electrode plate drying apparatus of claim 1, wherein the reflective portion comprises:
a first reflective portion configured to reflect the drying heat in a first direction; and
a second reflective portion obliquely connected to a side surface of the first reflective portion and configured to reflect the drying heat in a second direction different from the first direction.

3. The electrode plate drying apparatus of claim 2, wherein the first reflective portion is obliquely connected to a side surface of the second reflective portion at a first angle.

4. The electrode plate drying apparatus of claim 3, wherein a plurality of first perforated holes are formed on a surface of the first reflective portion.

5. The electrode plate drying apparatus of claim 4, wherein a plurality of the second reflective portions are obliquely connected to the side surface of the first reflective portion at a second angle.

6. The electrode plate drying apparatus of claim 5, wherein a plurality of second perforated holes are formed on a surface of the second reflective portion.

7. The electrode plate drying apparatus of claim 6, wherein the first reflective portion and the second reflective portion are connected to each other at an acute angle range.

8. The electrode plate drying apparatus of claim 1, wherein a plurality of reflective portions are installed on the ceiling of the drying chamber.

9. The electrode plate drying apparatus of claim 1, wherein a hot air supply portion supplying hot air in the direction of the electrode plate is installed on an upper portion of the drying chamber.

10. The electrode plate drying apparatus of claim 9, wherein the hot air supply portion comprises:
an air supply portion on the upper portion of the drying chamber, and configured to receive hot air and to supply it to an inside of the drying chamber; and
a guide portion configured to guide the hot air supplied through the air supply portion to be supplied to the inside of the drying chamber.

11. The electrode plate drying apparatus of claim 10, wherein a plurality of air supply portions are installed on the upper portion of the drying chamber.

12. The electrode plate drying apparatus of claim 11, wherein the guide portion has one side on which the an air supply portion of the plurality of air supply portions is installed and protrudes from an upper side of the drying chamber toward the inside of the drying chamber to guide the supply of hot air.

13. The electrode plate drying apparatus of claim 2, wherein the second reflective portion is rotatably connected to a side surface of the first reflective portion.

14. The electrode plate drying apparatus of claim 13, wherein a driving portion is on a side surface of the second reflective portion in the drying chamber and is configured to provide a rotational driving force to the second reflective portion.

15. The electrode plate drying apparatus of claim 14, wherein the driving portion is a cylinder member in which a rod portion is connected to a side surface of the second reflective portion.
